(19) United States
(12) Patent Application Publication
(10) Pub. No.: US 2012/0185787 A1
(43) Pub. Date: Jul. 19, 2012

(54) USER INTERFACE INTERACTION BEHAVIOR BASED ON INSERTION POINT

(75) Inventors: Michelle Lisse, Kirkland, WA (US); Cheyne Mathey-Owens, Seattle, WA (US); Sin Wa Chui, Redmond, WA (US); Tara Hopwood, Newcastle, WA (US); Jessica Best, Seattle, WA (US)

(73) Assignee: Microsoft Corporation, Redmond, WA (US)

(21) Appl. No.: 13/005,809

(22) Filed: Jan. 13, 2011

(51) Int. Cl. G06F 3/048

(52) U.S. Cl. 715/762

(57) ABSTRACT

Automatic manipulation of document user interface behavior is provided based on an insertion point. Upon placement of an insertion point within a displayed document, the behavior of the user interface is adjusted based on a next action of the user. If the user begins a drag action near the insertion point, he/she is enabled to interact with the content of the document (e.g. select a portion of text or object(s)). If the user begins a drag action at a location away from the insertion point, on the other hand, he/she is enabled to interact with the page (e.g. panning) Thus, the interaction behavior is automatically adjusted without additional action by the user or limitations on user action.

### BACKGROUND

Text and object based documents are typically manipulated through user interfaces employing a cursor and a number of control elements. A user can interact with the document by activating one or more of the control elements before or after indicating a selection on the document through cursor placement. For example, a portion of text or an object may be selected, then a control element for editing, copying, etc. of the selection activated. The user is then enabled to perform actions associated with the activated control element.

The behavior of a user interface enabling a user to interact with a document is typically limited based on the user action. For example, a drag action may enable the user to select a portion of text or one or more objects if it is a horizontal drag action, while the same action in vertical (or other) direction may enable the user to pan the current page. In other examples, a specific control element may have to be activated to switch between text selection and page panning modes. Heavy text editing tasks may be especially difficult using touch devices with conventional user interfaces due to conflict between panning and selection gestures.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to manipulation of document user interface behavior based on an insertion point. According to some embodiments, upon placement of an insertion point within a displayed document, the behavior of the user interface may be adjusted based a subsequent action of the user. If the user begins a drag action near the insertion point, he/she may be enabled to interact with the content of the document (e.g. select a portion of text or object(s)). If the user begins a drag action at a location away from the insertion point, he/she may be enabled to interact with the page (e.g. panning) Thus, the interaction behavior is automatically adjusted without additional action by the user or limitations on user action.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates examples of user interface behavior manipulation based on insertion point in a touch based computing device;

FIG. 2 illustrates an example user interface for a document, where user interface behavior can be manipulated based on an insertion point according to some embodiments;

FIG. 3 illustrates another example user interface for a document, where user interface behavior can be manipulated based on an insertion point according to other embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of automatically manipulating user interface behavior based on an insertion point according to embodiments.

### DETAILED DESCRIPTION

As briefly described above, a document user interface behavior may be manipulated based on an insertion point enabling a user to interact with the context of a page or the page itself depending on a location of the user's action relative to the insertion point. Thus, a user may be enabled to select text or object on a page without accidentally panning or otherwise interacting with the page while also not interfering when the user desires to interact with the page.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for enabling user interaction with content and pages of displayed documents. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

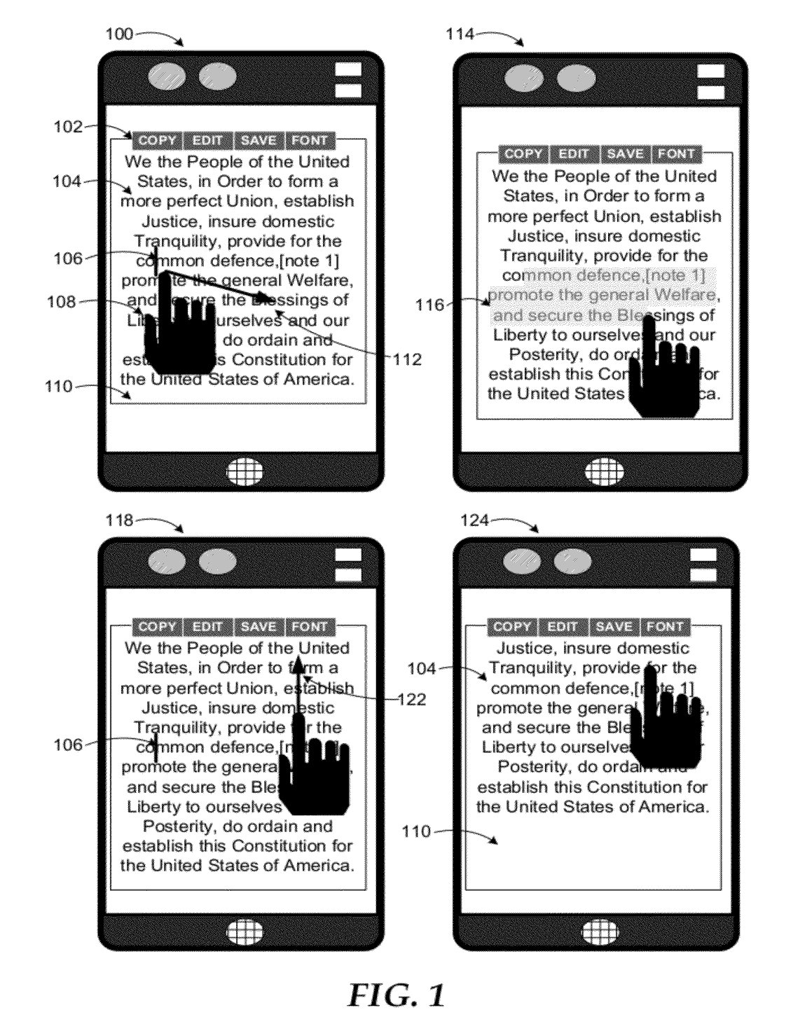

Referring to FIG. 1, examples of user interface behavior manipulation based on insertion point in a touch based computing device are illustrated. The computing devices and user interface environments shown in FIG. 1 are for illustration purposes. Embodiments may be implemented in various local, networked, and similar computing environments employing a variety of computing devices and systems.

In a conventional user interface, user interaction with the document is typically restricted based on multiple manual steps such as activation of one or more controls to switch between interacting with a page and interacting with contents of the page. Alternatively, limitations may be imposed on user action. For example, horizontal drag actions may enable a user to select text (or objects), while vertical drag actions may enable the user to pan the page. The latter is especially implemented in touch-based devices.

A system according to embodiments enables automatic user interface behavior manipulation based on a location of an insertion point and a location of a next user action. Such a system may be implemented in touch-based devices or other computing devices with more traditional input mechanisms such as mouse or keyboard. Gesture-based input mechanisms may also be used to implement automatic user interface behavior manipulation based on a location of an insertion point and a location of a next user action.

User interface 100 is illustrated on an example touch-based computing device. User interface 100 includes control elements 102 and page 110 of a document with textual content 104. According to an example scenario, the user 108 touches a point on page 110 placing insertion point 106. Subsequently, user 108 may perform a drag action 112 starting from about the insertion point 106.

User interface 114 illustrates results of the drag action 112. Because the drag action starts from about the insertion point 106 at user interface 100, a portion 116 of the textual content 104 is highlighted (indicating selection) up to the point where the user action ends. Thus, the user does not have to activate an additional control element or is subject to limitations like horizontal only drag action. Upon selection of the text portion, additional actions may be provided to the user through a drop down menu, a hover-on menu, and the like (not shown).

User interface 118 illustrates another possible user action upon placement of the insertion point 106. According to this example scenario, the user performs another drag action 122, this time starting at a point on the page that is away from the insertion point 106. The result of the drag action 122 is shown in user interface 124, where page 110 is panned upward (in the direction of the drag action). Thus, the user is enabled to interact directly with the page, again without activating an additional control element or being subject to limitations like vertical only drag action. The drag action and resulting panning may be in any direction and is not limited to vertical direction. The interaction with the page as a result of user action away from the insertion point does not alter page contents as shown in the diagram.

In a touch-based device as shown in FIG. 1, the insertion point placement and the drag actions may be input through touch actions such as tapping or dragging a finger (or similar object) on the screen of the device. According to some embodiments, they may also be placed via mouse/keyboard actions or combined with mouse/keyboard actions. For example, a user on a touch-enabled computing device including a mouse may click with a mouse to place an insertion point then drag with the finger.

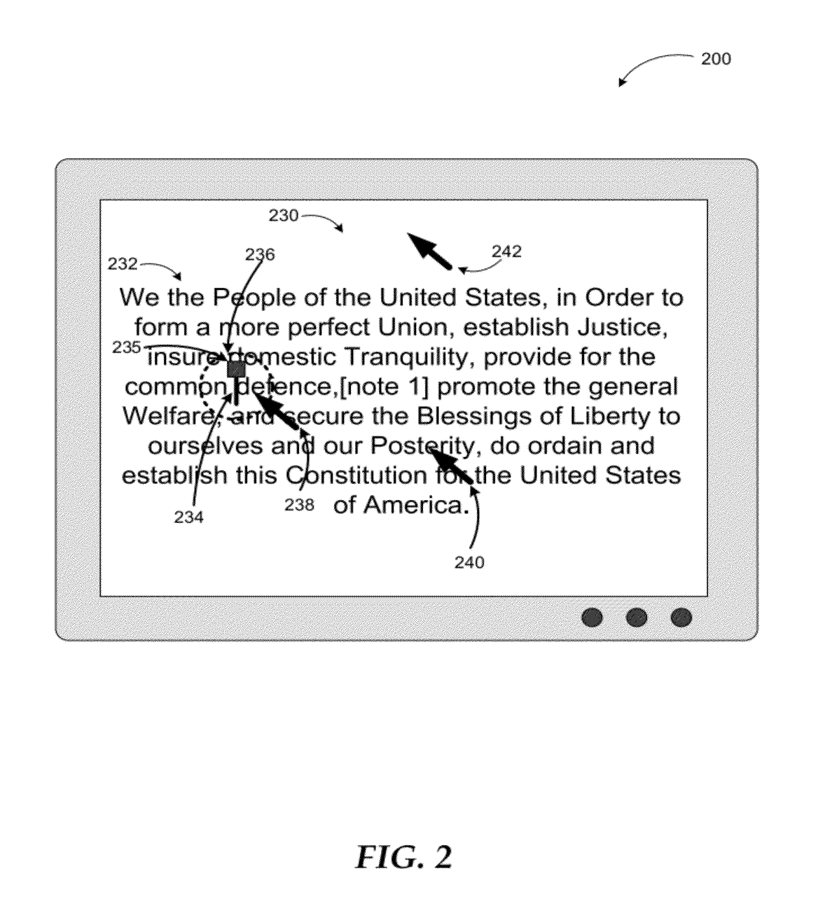

FIG. 2 illustrates an example user interface for a document, where user interface behavior can be manipulated based on an insertion point according to some embodiments. As discussed above, a system according to embodiments may be implemented in conjunction with touch-based and other input mechanisms. The example user interface of FIG. 2 is shown on display 200, which may be coupled to a computing device utilizing a traditional mouse/keyboard input mechanism or a gesture based input mechanism. In the latter case, an optical capture device such as a camera may be used to capture user gestures for input.

The user interface on display 200 also presents page 230 of a document with textual content 232. As first action in an example scenario, a user may place insertion point 234 on the page 230. Insertion point 234 is shown as a vertical line in FIG. 2, but its presentation is not limited to the example illustration. Any graphical representation may be used to indicate insertion point 234. To distinguish the insertion point 234 from the freely moving cursor, a blinking caret, a distinct shape, a handle 235, or similar mechanisms may be employed. For example, the insertion point may be the blinking cursor on text as opposed to the freely moving mouse cursor, which may also be represented as a vertical line over text but without blinking

Manipulation of the user interface behavior may be based on a location of the next user action compared to the location of the insertion point 234. To determine a boundary between enabling user interaction with the content of the document and with the page, a predefined area 236 may be used around the insertion point 234. FIG. 2 illustrates three example scenarios for the next user action. If the next user action originates at points 240 or 242 outside the predefined area 236, the user may be enabled to interact with the page. On the other hand, if the next user action starts at point 238 within the predefined area 236, the user may be enabled to interact with the content. For example, select a portion of the text. A size of the predefined area 236 may be selected based on an input method. For example, the area may be selected smaller for mouse inputs and larger for touch-based input because those two input styles have different accuracies.

As the cursor is moved, handle 235 may retain the same relative placement under the contact geometry. According to some embodiments, the user may be enabled to adjust the handle 235 to create a custom range of text. According to other embodiments, a magnification tool may be provided to place the insertion point. To trigger the magnification tool in a touch-based device, the user may press down on the selection handle to activate the handle. When the user presses on the same location without moving for a predefined period, the magnification tool may appear. Upon termination of the pressing, the action is complete and the selection handle may be placed in the pressed location.

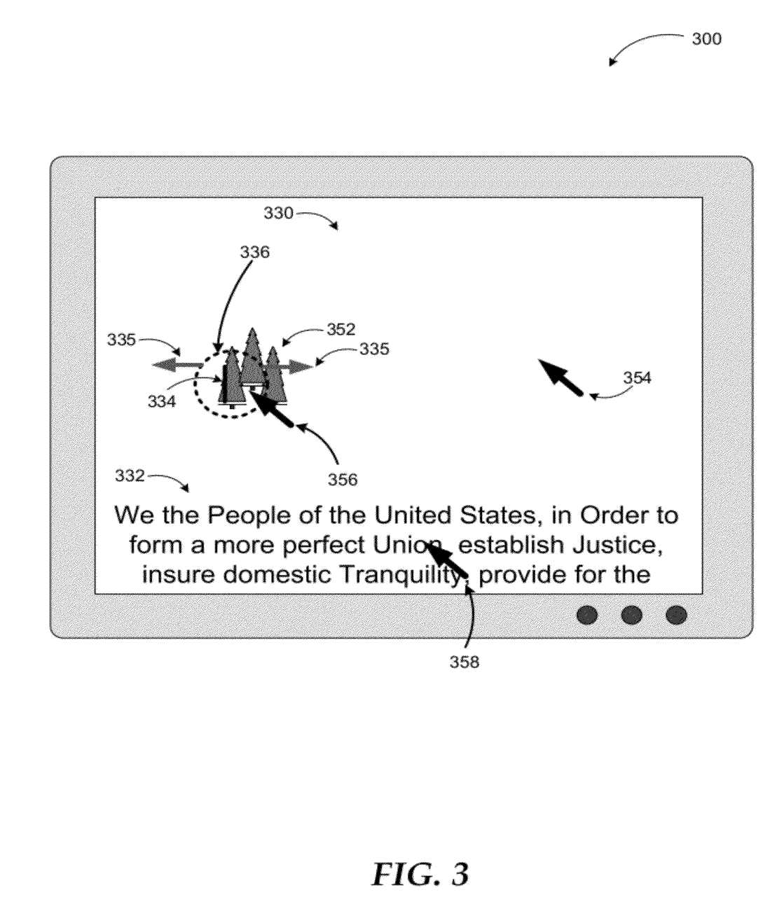

FIG. 3 illustrates another example user interface for a document, where user interface behavior can be manipulated based on an insertion point according to other embodiments. The user interface in FIG. 3 includes page 330 presented on display 300. Differently from the example of FIG. 2, page 330 includes textual content 332 and graphical objects 352.

Insertion point 334 is placed next to (or on) graphical objects 352. Thus, if the next user action starts at point 356 within predefined area 336 around insertion point 334, the user may be enabled to interact with the content (e.g. graphical objects 352). On the other hand, if the next user action starts at point 354 in the blank area of the page or at point 358 on the textual content, the user may be enabled to interact with the page itself instead of the content.

According to some embodiments, left and/or right arrows 335 may appear on either side of the insertion point 334 indicating interaction with content if the next action includes drag action from the insertion point. Once the user begins to drag from the insertion point 334, the arrow in the direction of their movement may be shown as feedback. Once the drag action is completed (e.g. lift up of finger on a touch-based device), both edges of the selection may be indicated with selection handles. According to further embodiments, if the document does not include editable content (e.g. a read-only email) the user interface may not allow an insertion point to be placed on the page.

The example systems in FIG. 1 through 3 have been described with specific devices, applications, user interface elements, and interactions. Embodiments are not limited to systems according to these example configurations. A system for manipulating user interface behavior based on insertion point location may be implemented in configurations employing fewer or additional components and performing other tasks. Furthermore, specific protocols and/or interfaces may be implemented in a similar manner using the principles described herein.

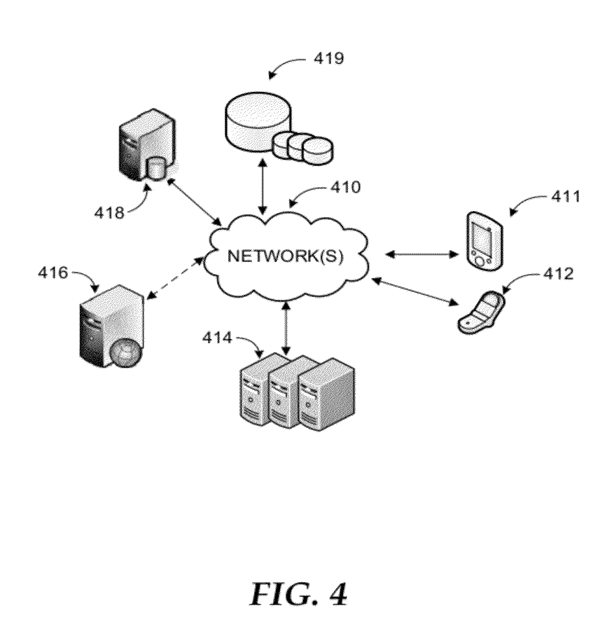

FIG. 4 is an example networked environment, where embodiments may be implemented. User interface behavior manipulation based on insertion point location may be implemented via software executed over one or more servers 414 such as a hosted service. The platform may communicate with client applications on individual computing devices such as a handheld computing device 411 and smart phone 412 (client devices') through network(s) 410.

Client applications executed on any of the client devices 411-412 may facilitate communications via application(s) executed by servers 414, or on individual server 416. An application executed on one of the servers may provide a user interface for interacting with a document including text and/or objects such as graphical objects, images, video objects, and comparable ones. A user's interaction with the content shown on a page of the document or the page itself may be enabled automatically based on a starting position of user action relative to the position of an insertion point on the page placed by the user. The user interface may accommodate touch-based inputs, device-based inputs (e.g. mouse, keyboard, etc.), gesture-based inputs, and similar ones. The application may retrieve relevant data from data store(s) 419 directly or through database server 418, and provide requested services (e.g. document editing) to the user(s) through client devices 411-412.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a platform providing user interface behavior manipulation based on an insertion point. Furthermore, the networked environments discussed in FIG. 4 are for illustration purposes only. Embodiments are not limited to the example applications, modules, or processes.

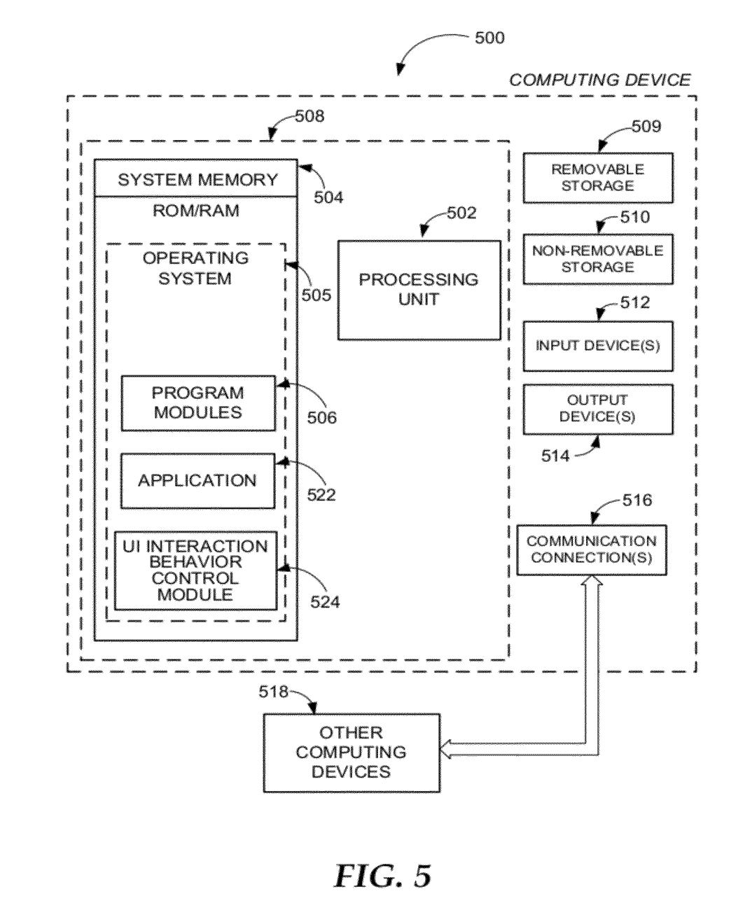

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing an application with document editing user interface according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS ® operating systems from MICROSOFT CORPORATION of Redmond, Wash.

The system memory 504 may also include one or more software applications such as program modules 506, application 522, and user interface interaction behavior control module 524. Application 522 may be a word processing application, a spreadsheet application, a presentation application, a scheduling application, an email application, a calendar application, a browser, and similar ones.

Application 522 may provide a user interface for editing and otherwise interacting with a document, which may include textual and other content. User interface interaction behavior control module 524 may automatically enable a user to interact with the content or a page directly without activating a control element or being subject to limitations on the action such as horizontal or vertical drag actions. The manipulation of the user interface behavior may be based on a relative location of where the user action (e.g. drag action) begins compared to an insertion point placed on the page by the user or automatically (e.g., when the document is first opened). The interactions may include, but are not limited to, touch-based interactions, mouse click or keyboard entry based interactions, voice-based interactions, or gesture-based interactions. Application 522 and control module 524 may be separate application or integrated modules of a hosted service. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

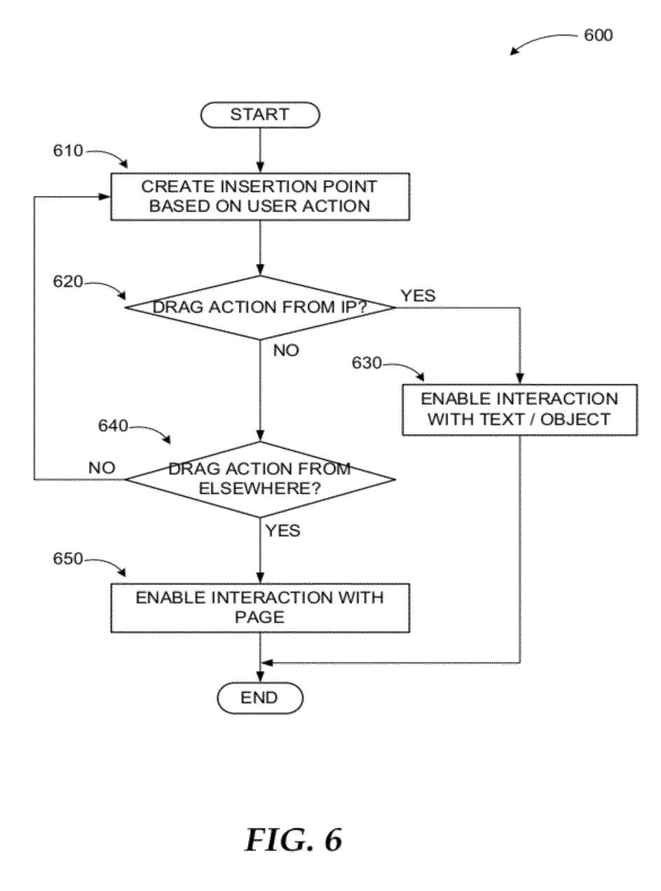

FIG. 6 illustrates a logic flow diagram for process 600 of automatically manipulating user interface behavior based on an insertion point according to embodiments. Process 600 may be implemented on a computing device or similar electronic device capable of executing instructions through a processor.

Process 600 begins with operation 610, where an insertion point is created on a displayed document in response to a user action. A document as used herein may include commonly used representations of textual and other data through a rectangularly shaped user interface, but is not limited to those. Documents may also include any representation of textual and other data on a display device such as bounded or un-bounded surfaces. Depending on content types of the document, the insertion point may be next to textual content or objects such as graphical objects, images, video objects, etc. At decision operation 620, a determination may be made whether a next action by the user is a drag action from the insertion point or not. The origination location of the next user action may be compared to the location of the insertion point based on a predefined distance from the insertion point, which may be dynamically adjustable based on physical or virtual display size, a predefined setting, and/or a size of the finger (or touch object) used for touch-based interaction according to some embodiments.

If the next action originated near the insertion point, the user may be enabled to interact with the content of the document (text and/or objects) such as selecting a portion of the content and subsequently being offered available actions at operation 630. If the next action does not originate near the insertion point, another determination may be made at decision operation 640 whether the action originates away from the insertion point such as elsewhere on the textual portion or in a blank area of the page. If the origination point of the next action is away from the insertion point, the user may be enabled to interact with the entire page at operation 650 such as panning the page, rotating the page, etc. The next action may be a drag action may be in an arbitrary direction, a click, a tap, a pinch, or similar actions.

The operations included in process 600 are for illustration purposes. User interface behavior manipulation based on location of insertion point may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method for manipulating user interface behavior, comprising:
creating an insertion point on a displayed document page;
detecting a user input on the displayed document page;
if the user input originates in a predefined area around the insertion point, enabling the user to interact with content of the page; and
if the user input originates outside the predefined area around the insertion point, enabling the user to interact with the page.

2. The method of claim 1, wherein the user input includes one of: a drag action in an arbitrary direction, a click, a tap, and a pinch.

3. The method of claim 1, wherein the interaction with the page includes at least one from a set of: panning, changing a page size, changing a page property, and changing a page view.

4. The method of claim 1, further comprising:
dynamically adjusting a size of the predefined area around the insertion point based on at least one of a physical size of a device displaying the document page, a size of a user interface displaying the document page, a predefined setting, a size of touch object used for touch-based interaction, and a type of user input method.

5. The method of claim 1, wherein the content includes at least one from a set of: a text, a graphical object, a table, an image, and a video object.

6. The method of claim 1, further comprising:
presenting the insertion point with a handle indicating an adjustability of user interface behavior.

7. The method of claim 6, further comprising:
enabling the user to adjust the handle in order to create a custom range of the content for selection.

8. The method of claim 1, further comprising:
presenting at least one of a left arrow and a right arrow near the insertion point indicating interaction with content if the user input includes drag action from within the predefined area.

9. The method of claim 8, further comprising:
upon detecting a drag action from within the predefined area displaying one of the arrows in a direction of the drag action as feedback.

10. The method of claim 1, wherein the user input is received through one of: a touch-based input, a mouse input, a keyboard input, a voice-based input, and a gesture-based input.

11. A computing device capable of manipulating user interface behavior, the computing device comprising:
a display configured to display a user interface presenting a document page;
an input component configured to receive one of: a touch-based input, a mouse input, a keyboard input, a voice-based input, and a gesture-based input;
a memory configured to store instructions; and
a processor coupled to the memory for executing the stored instructions, the processor configured to:
create an insertion point on the displayed document page in response to one of opening of the document and a user input;
detect a subsequent user input on the displayed document page;
if the subsequent user input originates in a predefined area around the insertion point, enable the user to interact with content of the page, the content comprising at least one from a set of: a text, a graphical object, an image, a video object, a table, and a text box; and
if the subsequent user input originates outside the predefined area around the insertion point, enable the user to interact with the page.

12. The computing device of claim 11, wherein the interaction with the content includes selection of a combination of text and an object.

13. The computing device of claim 11, wherein the subsequent user input is a drag action in an arbitrary direction.

14. The computing device of claim 11, wherein the processor is further configured to:
disable placement of the insertion point if a portion of the document, where the insertion point is being attempted to be placed lacks editable content.

15. The computing device of claim 11, wherein the predefined area around the insertion point has one of a fixed size and a dynamically adjustable size based on one of a physical size of the display and a virtual size of the user interface.

16. The computing device of claim 11, wherein the user interface is associated with one of: a word processing application, a spreadsheet application, a presentation application, a scheduling application, an email application, a calendar application, and a browser.

17. A computer-readable storage medium with instructions stored thereon for manipulating user interface behavior, the instructions comprising:
creating an insertion point on a displayed document page in response to a touch-based action;
detecting a subsequent user action on the displayed document page;
if the subsequent user action originates in a predefined area around the insertion point, enabling the user to interact with at least a portion of content of the page; and
if the subsequent user action originates outside the predefined area around the insertion point, enabling the user to interact with the page performing at least one from a set of: panning the page, zooming the page, rotating the page, and activating a menu.

18. The computer-readable medium of claim 17, wherein the instructions further comprise:
adjusting a size of the predefined area based on a type of input used for the subsequent user action.

19. The computer-readable medium of claim 18, wherein enabling the user to interact with a portion of the content includes enabling the user to select the portion of the content.

20. The computer-readable medium of claim 18, wherein the instructions further comprise:
following placement of the insertion point, presenting at least one arrow near the insertion point indicating interaction with content if the subsequent user action includes drag action from within the predefined area; and
upon detecting the drag action from within the predefined area displaying one of the arrows in a direction of the drag action.
